(19) United States
(12) Patent Application Publication
(10) Pub. No.: US 2010/0208300 A1
(43) Pub. Date: Aug. 19, 2010

(54) IMAGE PROCESSING APPARATUS, SERVER APPARATUS, CONTROL METHOD THEREFOR, AND STORAGE MEDIUM

(75) Inventor: Atsushi Kamasuka, Matsudo-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/707,329

(22) Filed: Feb. 17, 2010

(30) Foreign Application Priority Data
Feb. 18, 2009 (JP) 2009-035399

(51) Int. Cl. G06F 15/00

(52) U.S. Cl. 358/1.15

(57) ABSTRACT

An image processing apparatus that makes it possible to exchange setting information by easy operations, thus improving convenience for users. The image processing apparatus is connected to an external device via a network. Screen information including a display for inputting information to the external device and instructing to set the inputted information as setting information on the external device is requested from the external device. An operational screen is displayed based on a response from the external device in response to the request. A user is provided with a display for instructing to set setting information currently set in the image processing apparatus as setting information on the external device when the operational screen is displayed.

### BACKGROUND OF THE INVENTION

1. Field of the Invention

The present invention relates to an image processing apparatus connected to an external device via a network, a server apparatus connected to the image processing apparatus via the network, a control method for them, and a computer-readable storage medium storing a program.

2. Description of the Related Art

Conventionally, there has been HTML (Hypertext Markup Language) as a markup language for use in description of a web page. With HTML, a web page creator (web server side) can request a user (client side) who reads the web page to input information using a form. An HTML form is effective means for a wide variety of applications requiring input from a user.

Also, there is RFC (Request for Comments) as a group of technical specifications for the Internet. In RFC 1867, a method of “uploading a file based on a form in HTML” is disclosed. This method makes it possible to expand bidirectionality of information transmission using an HTML form, and upload files accumulated in a client platform as an input to a distributed application server. Based on this method, general web browsers being in practical use and many web contents are implemented.

FIG. 8 is a view showing an exemplary screen layout of a form displayed on a general web browser by a prior art of RFC 1867. A screen of the form shown in FIG. 8 is generated based on an HTML document shown in FIG. 7, and displayed in a content display area 1101 of the web browser. On the screen, a display 1102 (Device information will be sent) corresponds to an h1 element in the sixth line in FIG. 7. An area enclosed by a line of a display 1103 corresponds to a file-type input element in the eighth line in FIG. 7. A display 1104 corresponds to a submit-type input element in the ninth line in FIG. 7.

The area of the display 1103 is an implementation based on a method adopted generally for conventional web browsers, and this implementation is indicated in RFC 1867 as well. In the area of the display 1103, a display 1105 corresponds to a file name input field. A list of file paths (file names) in a file system of a file to be uploaded can be typed in from the file name input field.

The display 1106 corresponds to a file selection button. The file selection button is depressed to enter a file selection mode suitable for a platform on which the web browser is operating. In the web browser operating on a general-purpose computer, a file selection dialogue is opened in the file selection mode, so that a file that should be uploaded can be selected from a file group stored in a file system.

Also, there has conventionally been produced a remote user interface for providing a remote web browser with a user interface of an apparatus, which has a web server function in addition to original functions of the apparatus. Also, there has been known a technique that an apparatus has a web client (web browser) function in addition to original functions of the apparatus, and various contents are obtained (downloaded) from a remote web server and browsed to assist the functions of the apparatus.

As an example of the apparatuses having the above functions, there is an image processing apparatus having a web browser incorporated therein. In the image processing apparatus of this type, a function of not only displaying and registering the status, information, and settings of the apparatus, but also taking in/out various kinds of information on the apparatus as files is realized on the web browser (see, for example, Japanese Laid-Open Patent Publication (Kokai) No. 2005-149320).

In the image processing apparatus described in Japanese Laid-Open Patent Publication (Kokai) No. 2005-149320, by accessing a web server incorporated in another image processing apparatus from the web browser of the own apparatus, a status, settings and so on of the other apparatus can be read and registered from the own apparatus.

However, to send setting information on the own apparatus to the other apparatus and set the same as setting information on the other apparatus, setting information on the own apparatus must be stored in advance as a file in a storage device such as an HDD. Then, a web server of an image processing apparatus as a transmission destination is re-accessed so as to upload the stored file. Thus, the other apparatus can be operated from the own apparatus via the web browser, but on the other hand, operation is complicated in exchange of setting information.

### SUMMARY OF THE INVENTION

The present invention provides an image processing apparatus, a server apparatus, and a control method therefor, which make it possible to exchange setting information by easy operations, thus improving convenience for users, as well as a computer-readable storage medium storing a program.

Accordingly, in a first aspect of the present invention, there is provided an image processing apparatus connected to an external device via a network, comprising a requesting unit adapted to request, from the external device, screen information including a first instruction button for inputting information to the external device and instructing to set the inputted information as setting information on the external device, a display unit adapted to display an operational screen based on a response from the external device in response to the request by the requesting unit, a providing unit adapted to provide a user with a second instruction button for instructing to set setting information currently set in the image processing apparatus as setting information on the external device when the display unit displays the operational screen.

Accordingly, in a second aspect of the present invention, there is provided a server apparatus connected to an image processing apparatus via a network, comprising a receiving unit adapted to receive from the image processing apparatus a request for screen information including a first instruction button for inputting information to the server apparatus and instructing to set the inputted information as setting information on the server apparatus, a determination unit adapted to determine whether the image processing apparatus that has made the request is a specific image processing apparatus when the receiving unit receives the request, and a transmission unit adapted to, when as a result of the determination by the determination unit, the image processing apparatus that has made the request is a specific image processing apparatus, send screen information for displaying an operational screen including the first instruction button for instructing to input information selected by a user from information stored in a storage unit of the image processing apparatus to the server apparatus so as to set the selected information as setting information on the server apparatus, and a second instruction button for instructing to read setting information currently set in the image processing apparatus and inputting the read setting information to the server apparatus so as to set the read setting information as setting information on the server apparatus to the image processing apparatus that has made the request.

Accordingly, in a third aspect of the present invention, there is provided a control method for an image processing apparatus connected to an external device via a network, comprising a requesting step of requesting, from the external device, screen information including a first instruction button for inputting information to the external device and instructing to set the inputted information as setting information on the external device, a display step of displaying an operational screen on a display unit based on a response from the external device in response to the request in the requesting step, a providing step of providing a user with a second instruction button for instructing to set setting information currently set in the image processing apparatus as setting information on the external device when the operational screen is displayed in the display step.

Accordingly, A control method for a server apparatus connected to an image processing apparatus via a network, comprising a receiving step of receiving from the image processing apparatus a request for screen information including a first instruction button for inputting information to the server apparatus and instructing to set the inputted information as setting information on the server apparatus, a determination step of determining whether the image processing apparatus that has made the request is a specific image processing apparatus when the request is received in the receiving step, and a transmission step of, when as a result of the determination in the determination step, the image processing apparatus that has made the request is a specific image processing apparatus, sending screen information for displaying an operational screen including the first instruction button for instructing to input information selected by a user from information stored in a storage unit of the image processing apparatus to the server apparatus so as to set the selected information as setting information on the server apparatus, and a second instruction button for instructing to read setting information currently set in the image processing apparatus and inputting the read setting information to the server apparatus so as to set the read setting information as setting information on the server apparatus to the image processing apparatus that has made the request.

Accordingly, in a fifth aspect of the present invention, there is provided a computer-readable storage medium storing a program for causing a computer to execute a control method for an image processing apparatus.

Accordingly, in a sixth aspect of the present invention, there is provided a computer-readable storage medium storing a program for causing a computer to execute a control method for a server apparatus.

According to the present invention, it is possible to exchange setting information by easy operations, thus improving convenience for users.

Further features of the present invention will become apparent from the following description of exemplary embodiments (with reference to the attached drawings).

### BRIEF DESCRIPTION OF THE DRAWINGS

FIG. 1 is a block diagram schematically showing an overall arrangement of an HTTP client/server system according to a first embodiment of the present invention.

FIG. 2 is a block diagram schematically showing a software arrangement of an image processing apparatus in a network system.

FIG. 3 is a block diagram schematically showing in detail an arrangement of the image processing apparatus.

FIG. 4 is a block diagram schematically showing in detail an arrangement of a console and a console I/F.

FIG. 5 is a view schematically showing a screen layout of a web browser displayed on an LCD display unit by a user interface module.

FIG. 6 is a sequence diagram showing a flow of request and response by HTTP.

FIG. 7 is a view showing an exemplary HTML document that includes a form and for which a POST method is designated as a form transmission method.

FIG. 8 is a view showing an exemplary screen layout of a form displayed on an ordinary web browser by a prior art of RFC 1867.

FIG. 9 is a view showing an exemplary screen displayed in a content display area of the web browser based on the HTML document shown in FIG. 7.

FIG. 10 is a flowchart showing procedures of a layout process on an object corresponding to a file-type INPUT element executed by the web browser of the image processing apparatus.

FIG. 11 is a view showing an exemplary dialogue window displayed on the web browser of the image processing apparatus while setting information on the image processing apparatus is being read.

FIG. 12 is a flowchart showing procedures of a process for reading setting information on the image processing apparatus, which is carried out by the image processing apparatus.

FIG. 13 is a view showing an exemplary dialogue window displayed so as to select a box in which a setting information file is stored.

FIG. 14 is a view showing an exemplary dialogue window displayed so as to select a setting information file from a box.

FIG. 15 is a flowchart showing the procedure of a form submitting process carried out by the web browser of the image processing apparatus.

FIG. 16 is a flowchart showing procedures of a process carried out by a web server of an image processing apparatus in a case where a page to which setting information is uploaded is requested according to a second embodiment of the present invention.

### DESCRIPTION OF THE EMBODIMENTS

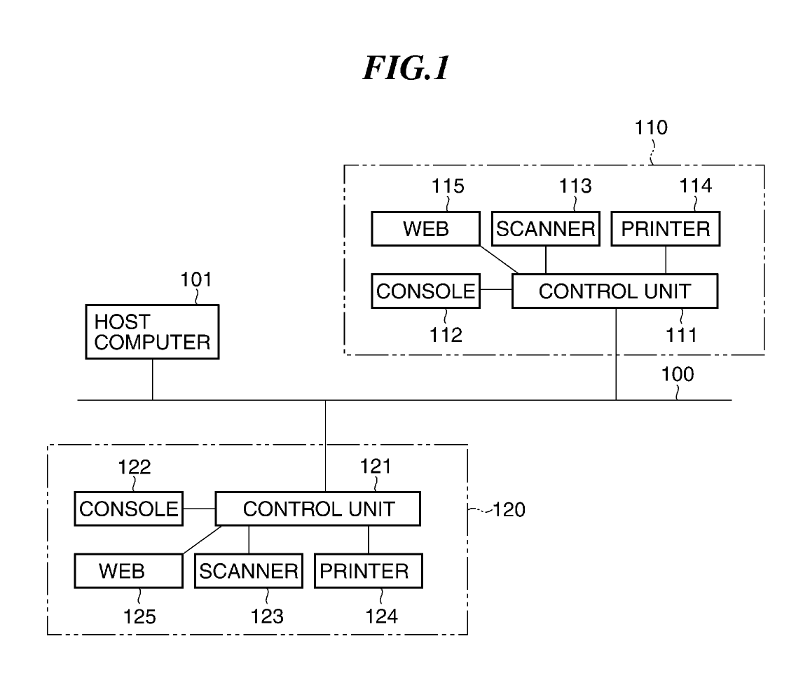

The present invention will now be described in detail with reference to the drawings showing preferred embodiments thereof. FIG. 1 is a block diagram schematically showing an overall arrangement of an HTTP client/server system according to a first embodiment of the present invention.

Referring to FIG. 1, the system is arranged such that an image processing apparatus 110, an image processing apparatus 120, and a host computer 101 are connected together via a LAN 100. It should be noted that FIG. 1 shows an exemplary arrangement of a network system, and the number of connected image processing apparatuses and so on is not limited to the illustrated arrangement.

The image processing apparatus 110 is implemented as a multifunction peripheral (MFP) that carries out input/output of images (reading of an image from an original, and formation of an image on paper), transmission and reception of information, and various kinds of image processing. The image processing apparatus 110 has a scanner 113, a printer 114, a console 112, a web browser and web server module (WEB) 115, and a control unit 111. The image processing apparatus 110 has an HTTP client function of communicating with a server (in the present embodiment, the image processing apparatus 120) using HTTP (Hypertext Transfer Protocol).

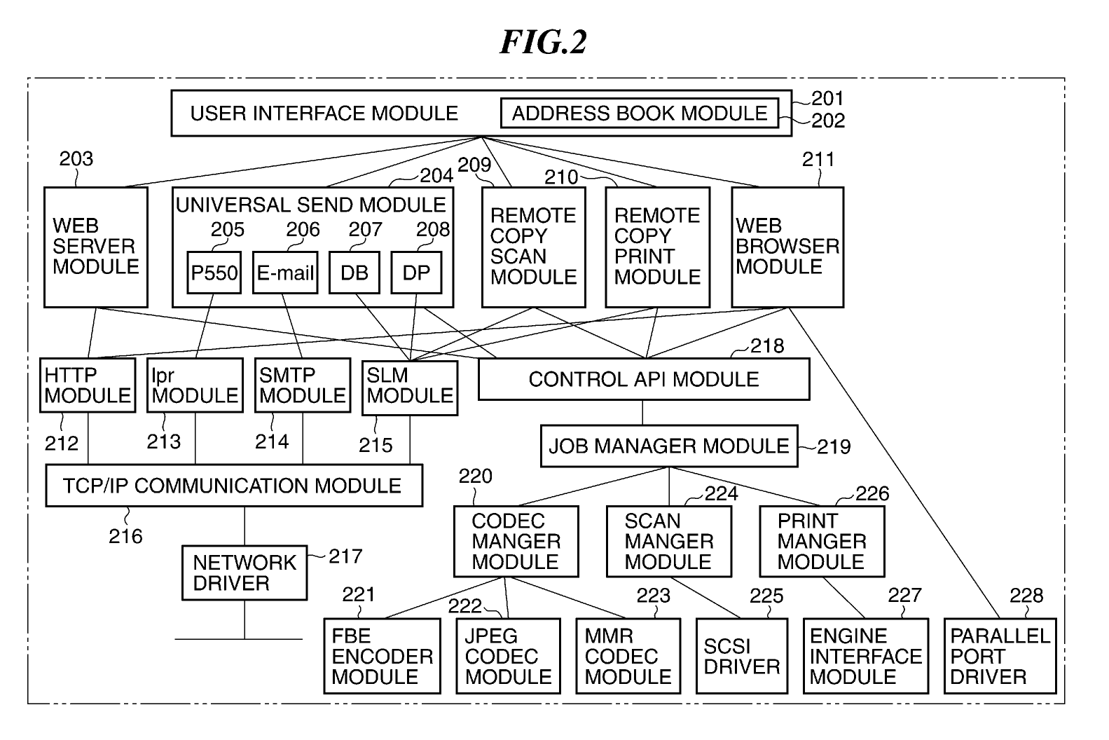

The scanner 113 is an image input device that reads an image from an original. The printer 114 is an image output device that forms an image on paper. The console 112 is a user interface for use in carrying out various operations and configuring various settings. The web browser and web server module 115 will be described later with reference to FIG. 2. The control unit 111 is connected to the LAN 100, and outputs instructions to the above-mentioned components and controls them.

The image processing apparatus 120 has the same arrangement as the arrangement of the image processing apparatus 110, and is connected to the LAN 100. The image processing apparatus 120 has a scanner 123, a printer 124, a console 122, a web browser and web server module (WEB) 125, and a control unit 121. The image processing apparatus 120 has an HTTP server function of communicating with a client (in the present embodiment, the image processing apparatus 110) using HTTP.

The host computer 101 is connected to the LAN 100. The host computer 101 has a web browser, described later, and displays, for example, statuses of the image processing apparatus 110 and the image processing apparatus 120 based on an analysis of HTML files received from the image processing apparatus 110 and the image processing apparatus 120.

In the present embodiment, the image processing apparatus 120 is accessed from the image processing apparatus 110, and a web browser of the image processing apparatus 110 displays an operational screen according to an HTML file provided by a web server of the image processing apparatus 120. Then, in accordance with an instruction given via the displayed operational screen, setting information on the image processing apparatus 110 is sent to the image processing apparatus 120 and set as setting information on the image processing apparatus 120.

FIG. 2 is a block diagram schematically showing a software arrangement of the image processing apparatus 110 shown in FIG. 1. It should be noted that software arrangements of the image processing apparatus 110 and the image processing apparatus 120 are the same, and therefore, the software arrangement of the image processing apparatus 110 will now be described.

Referring to FIG. 2, the image processing apparatus 110 has a user interface (hereinafter referred to as “UI”) module 201 and other modules, described later. The UI module 201 mediates user operations to the image processing apparatus 110 when a user carries out various operations and configures various settings on the image processing apparatus 110. The UI module 201 requests processing and sets data by transferring input information to various modules, described later, in accordance with user's operations.

An address-book module 202 is a database module that manages transmission destinations, communication destinations, and so on for data. Regarding data managed by the address-book module 202, data can be added, deleted, and obtained through operations from the UI module 201. Moreover, the address-book module 202 gives information indicative of transmission destinations and communication destinations of data to modules, described later.

A web-server module 203 gives management information on the image processing apparatus 110 to a web client (for example, the host computer 101) in response to a request from the web client. The management information is obtained via a universal-send module 204, a remote-copy-scan module 209, a remote-copy-print module 210, and a control API module 218, described later. The obtained management information is given to the web client via an HTTP module 212, a TCP/IP communication module 216, and a network driver 217.

A web browser module 211 reads and displays information on various websites (homepages) on the Internet or an intranet. A detailed description of an arrangement of the web browser module 211 will be given later.

The universal-send module 204 is responsible for distributing data. The universal-send module 204 distributes data designated by the user via the UI module 201 to designated communication (output) destinations. Also, when the user gives a distributed data generating instruction using a scanner function of the image processing apparatus 110, the universal-send module 204 causes the image processing apparatus 110 to operate via the control API module 218, thus generating data.

The universal-send module 204 includes a module (P550) 205, a module (e-mail) 206, a (DB) module 207, and a (DP) module 208. The module (P550) 205 is executed when a printer is designated as an output destination. The module (e-mail) 206 is executed when an e-mail address is designated as an output destination. The (DB) module 207 is executed when a database is designated as an output destination. The (DP) module 208 is executed when the image processing apparatus 120 having the arrangement similar to the arrangement of the image processing apparatus 110 is designated as an output destination.

The remote-copy-scan module 209 reads image information using the scanner function of the image processing apparatus 110, and outputs the read image information to the other image processing apparatus 120 connected to the LAN 100. This makes it possible to execute a copy function, which is realized by an image processing apparatus alone, using another image processing apparatus.

The remote-copy-print module 210 outputs the image information, which is obtained by the other image processing apparatus 120 connected to the LAN 100, using a printer function of the image processing apparatus 110. This makes it possible to execute the copy function, which is realized by an image processing apparatus alone, using another image processing apparatus.

The HTTP module 212 is used when the image processing apparatus 110 carries out communication using HTTP, and provides a communication function to the web-server module 203 and the web browser module 211 using the TCP/IP communication module 216. Moreover, the HTTP module 212 supports various protocols used on a web such as HTTP, and provides a communication function using protocols ensuring security.

An lpr module 213 provides a communication function to the module (P550) 205 in the universal-send module 204 using the TCP/IP communication module 216.

An SMTP module 214 provides a communication function to the module (e-mail) 206 in the universal-send module 204 using the TCP/IP communication module 216.

An SLM (salutation-manager) module 215 provides a communication function to the (DB) module 207 and the (DP) module 208 in the universal-send module 204 using the TCP/IP communication module 216. The SLM module 215 also provides a communication function to the remote-copy-scan module 209 and the remote-copy-print module 210.

The TCP/IP communication module 216 provides a network communication function to each of the above modules using the network driver 217. The network driver 217 controls a part physically connected to the network.

The control API module 218 provides interfaces for downstream modules such as a job-manager module 219 to the upstream modules such as the universal-send module 204. Thus, the interdependence between the upstream modules and the downstream modules is alleviated, and the flexibility of use can be enhanced.

The job-manager module 219 interprets various processes prescribed by the above modules via the control API module 218, and gives instructions to modules 220, 224, and 226. The job-manager module 219 also consolidates hardware-related processes carried out within the image processing apparatus 110.

The CODEC-manager module 220 manages and controls various kinds of data compression and decompression in process prescribed by the job-manager module 219.

An FBE-encoder module 221 compresses data, which is read by scanning process carried out by the job-manager module 219 and the scan-manager module 224, using FBE format.

A JPEG-CODEC module 222 carries out JPEG compression process on data read by scanning process or printing process, and JPEG decompression process on print data. The scanning process is carried out by the job-manager module 219 or the scan-manager module 224. The printing process is carried out by the print-manager module 226.

An MMR-CODEC module 223 carries out MMR compression process on data read by scanning process or printing process, and MMR decompression process on print data. The scanning process is carried out by the job-manager module 219 or the scan-manager module 224. The printing process is carried out by the print-manager module 226.

The scan-manager module 224 manages and controls scanning process prescribed by the job-manager module 219. Communications between the scan-manager module 224 and the scanner 113 internally connected to the image processing apparatus 110 are carried out via an SCSI driver 225.

The print-manager module 226 manages and controls printing process prescribed by the job-manager module 219. An interface between the print-manager module 226 and the printer 114 is provided by an engine-interface (I/F) module 227.

A parallel port driver 228 provides an interface for use in outputting data to an output device, not shown, via a parallel port.

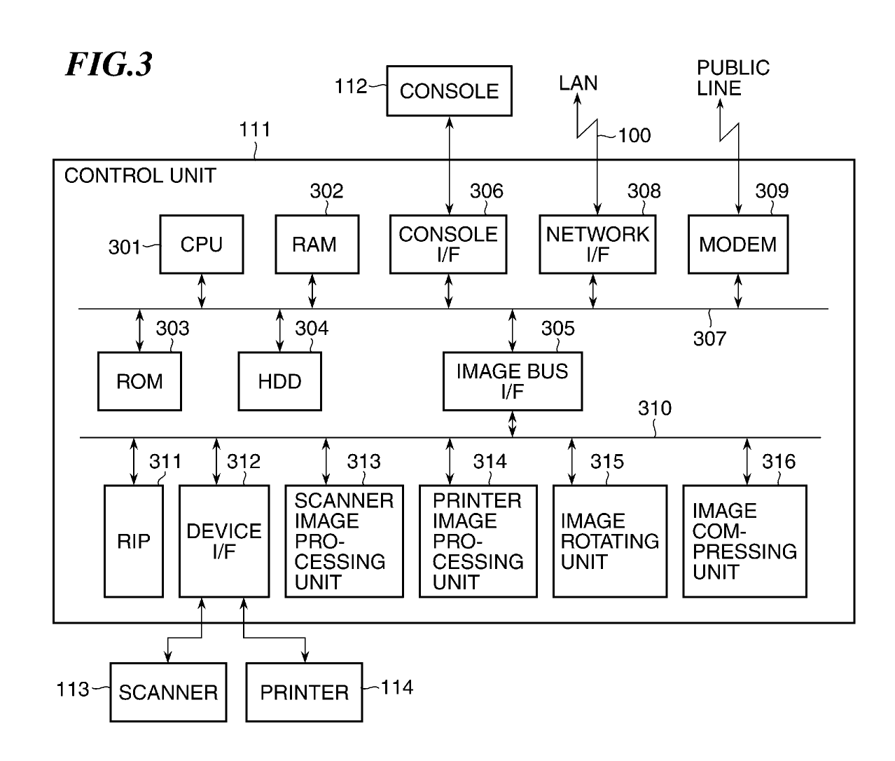

FIG. 3 is a block diagram schematically showing in detail an arrangement of the image processing apparatus 110. It should be noted that arrangements of the image processing apparatus 110 and the image processing apparatus 210 are the same, and therefore, the arrangement of the image processing apparatus 110 will be described.

Referring to FIG. 3, the control unit 111 has the scanner 113 as an image input device and the printer 114 as an image output device connected thereto, and controls them. Also, the control unit 111 is connected to the LAN 100 and a public line, and inputs and outputs image information and device information via them. The control unit 111 has a CPU 301, a RAM 302, a ROM 303, a console interface (hereinafter referred to as “I/F”) 306, a network I/F 308, a device I/F 312, a scanner image processing unit 313, a printer image processing unit 314, and so on.

The CPU 301 is connected to the RAM 302, the ROM 303, an HDD (hard disk drive) 304, an image bus I/F 305, the console I/F 306, the network I/F 308, and a modem 309 via a system bus 307. The CPU 301 carries out process shown in flowcharts, described later.

The RAM 302 is used as a work memory that provides a work area for the CPU 301, and an image memory that temporarily stores image data. The ROM 303 is a boot ROM, in which a system boot program is stored. The HDD 304 stores system software, image data, and so on.

A description will now be given of a box function relating to the present invention. The HDD 304 of the image processing apparatus has a temporary area and a box area. The temporary area is an area in which image data read from an original by the scanner 113, setting information to be sent, and so on are temporarily stored. Such data is deleted after completion of a job. In the temporary area is stored device information (for example, information indicative of a destination to which a facsimile is sent from the image processing apparatus) read by the CPU 301 when “Send information on this device” is designated by a user on a screen shown in FIG. 9, described later.

The box area is an area in which an image read from an original by the scanner 113, image data obtained by decompressing a PDL image sent from the host computer 101, or device information, or the like is stored in accordance with an instruction by the user. The box area is comprised of a plurality of boxes (for example, 100). The boxes have respective numbers assigned thereto so that they can be identified. In the box area, setting information read from the CPU 301 when “Select from boxes” is designated by the user on the screen shown in FIG. 9, described later.

The console I/F 306 is an interface for inputting and outputting data to and from the console 112. The console I/F 306 outputs image data to be displayed on the console 112 to the console 112, and sends information inputted via the console 112 by the user to the CPU 301.

The network I/F 308 is connected to the LAN 100, and inputs and outputs information to and from the LAN 100. The modem 309 is connected to the public line, and inputs and outputs information to and from the public line. The image bus I/F 305 is a bus bridge that connects to each other a system bus 307 and an image bus 310 transferring image data at high speed, and converts data structure.

To the image bus 310 are connected a RIP (raster image processor) 311, the device I/F 312, the scanner image processing unit 313, the printer image processing unit 314, an image rotating unit 315, and an image compressing unit 316. The RIP 311 rasterizes a PDL code received via the LAN 100, for example into a bitmap image. The device I/F 312 connects together the scanner 113 and the printer 114 and the control unit 111. The device I/F 312 carries out synchronous-to-asynchronous conversion on image data.

The scanner image processing unit 313, for example, corrects, processes and edits image data inputted by the scanner 113. The printer image processing unit 314 carries out, for example, correction and resolution conversion on image data outputted from the printer 114. The image rotating unit 315 rotates image data. The image compressing unit 316 applies JPEG compression and decompression process to multi-valued image data, and compression and decompression process of JBIG, MMR, or MH to binary image data.

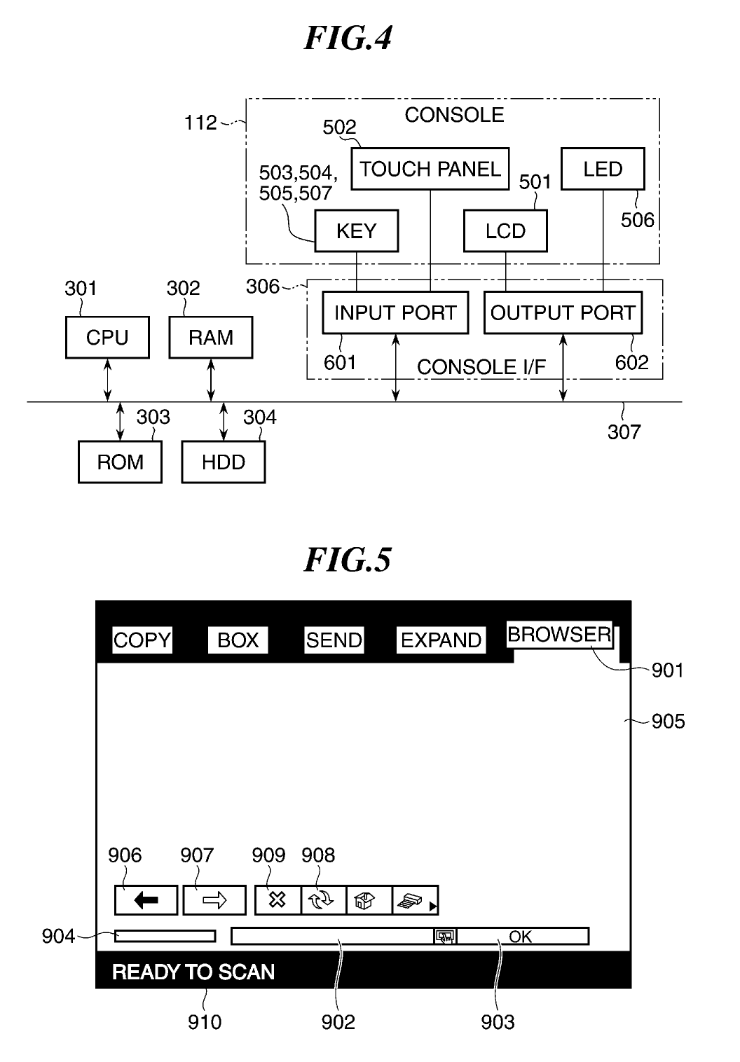

FIG. 4 is a block diagram schematically showing in detail an arrangement of the console 112.

Referring to FIG. 4, the console 112 has an LCD display unit 501, a touch panel 502, an LED display unit 506, and various hardware keys 503 to 507. The console I/F 306 has an input port 601 for controlling user inputs, and an output port 602 for controlling a screen output device. The input port 601 passes, to the CPU 301, user inputs from the touch panel 502 and a key group including various hardware keys. The CPU 301 generates display screen data on the LCD display unit 501 via the output port 602. Also, the CPU 301 controls the LED display unit 506 via the output port 602 as required.

FIG. 5 is a view schematically showing a screen layout of a web browser displayed on the LCD display unit 501 by the UI module 201.

Referring to FIG. 5, tabs 901, a URL input field 902, an OK button 903, a progress bar 904, and a content display area 905 are displayed on LCD display unit 501. Further, a back button 906, a next button 907, a reload button 908, a stop button 909, and a status area 910 are displayed on LCD display unit 501.

The tab 901 switches between screens for a web browser function and other functions (copy, box, send, and expand). The URL input field 902 is a field into which the user types in the URL of a desired resource. When the user presses the URL input field 902, a virtual full keyboard (not shown) for typing in characters is displayed. The user can type in a desired character string using software keys emulating a key top.

The OK button 903 is a software key for confirming the inputted URL character string. When the URL is confirmed, the web browser module 211 issues an HTTP request for obtaining the resource. The progress bar 904 indicates the progress of content acquisition process in response to the HTTP request. The content display area 905 is an area where the obtained resource is displayed. The back button 906 is a software key for going back a content display history and displaying a content displayed before the currently-displayed content. The next button 907 is a software key for going back to the display of a content displayed after the currently-displayed content when the content display history is displayed back. The reload button 908 is a software key for reacquisition and redisplay of the currently-displayed content. The stop button 909 is a software key for stopping the content acquisition process being in execution.

The status area 910 is an area where a message from various functions of the image processing apparatus is displayed. In the status area 910, a message for alerting the user can be displayed from the scanner 113, the printer 114, and other functions even while a web browser screen is being displayed. Moreover, in the status area 910, a message can be displayed from a web browser function as well. The web browser function displays a character string of a linked URL, a character string of a content title, a message designated by a script, and so on.

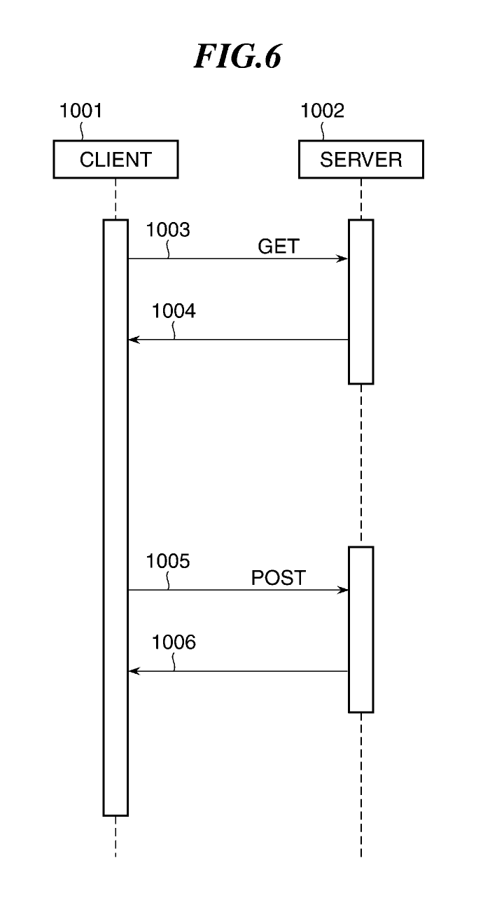

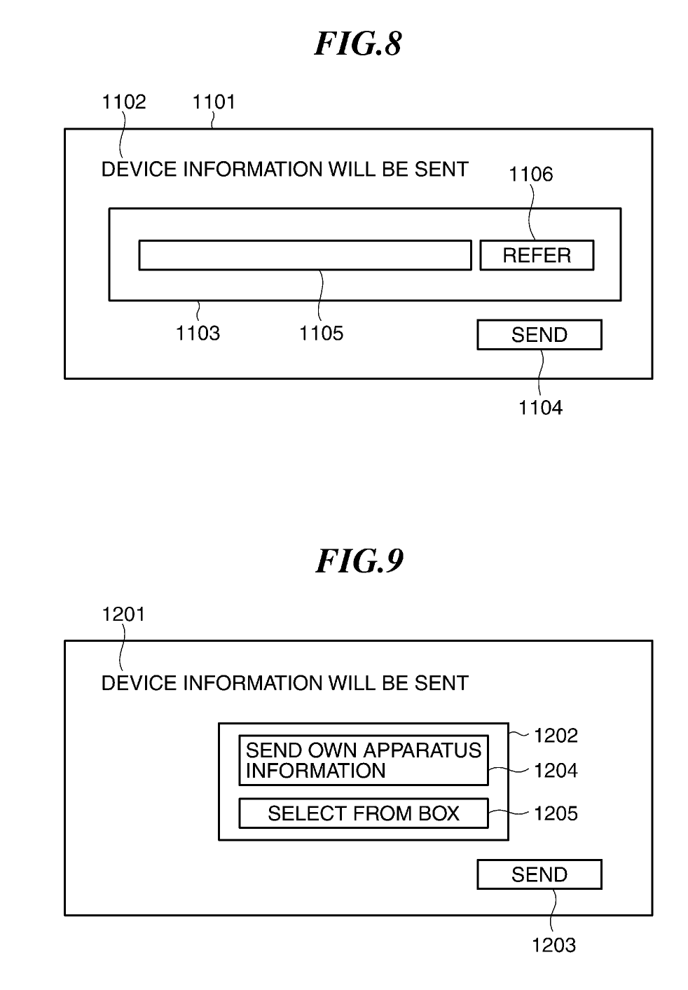

Referring next to FIGS. 6 to 15, a detailed description will be given of an operation of the HTTP client/server system according to the present embodiment arranged as described above.

FIG. 6 is a sequence diagram showing a flow of request and response by HTTP. Referring to FIG. 6, a client 1001 is software that sends an HTTP request to a server 1002 and receives an HTTP response from the server 1002. The software corresponds to a web browser incorporated in the image processing apparatus 110, or a general web browser operating on a PC (personal computer), a PDA (personal digital assistant), a cellular phone, or the like. It should be noted that various kinds of software that access a web server similarly to a web browser and use and relay services may be employed.

The server 1002 is software that receives an HTTP request from the client 1001, carries out the corresponding processing, and sends an HTTP response to the client 1001. The software corresponds to an HTTP server including software operating on a web server incorporated in the image processing apparatus 120.

The client 1001 can send an HTTP request using a GET method or a POST method. First, a description will be given of a case where an HTTP request is sent using the GET method. When the client 1001 is to send an HTTP request 1003 to the server 1002 using the GET method, a resource is generally designated in URI (Uniform Resource Identifier) (in particular, URL) format. The server 1002 obtains or generates data corresponding to the resource designated in the HTTP request 1003, and sends the data in an HTTP response 1004 to the client 1001.

When the designated resource corresponds to a static file, the server 1002 reads the corresponding file from, for example, a file system of the server 1002, and obtains data thereof. On the other hand, when the designated resource corresponds to process of, for example, a CGI (Common Gateway Interface) program or a Servlet, the server 1002 carries out the corresponding process. The process is to generate a response to the request. In this process, side effects such as execution of a business logic and access to a backend DBMS (database management system) required to offer a predetermined service are produced.

The server 1002 sends data generated as a result of the process back to the client 1001. For example, when a resource for displaying consumable information indicative of consumables for the image processing apparatus (paper, toner, and so on) is designated, software for obtaining the consumable information is executed. As a result, the software carries out a process in which records such as the statuses of paper, toner, and so on are referred to from setting information, and the information is formatted in HTML or XML to generate data.

In the client 1001, when data obtained from the HTTP response 1004 from the server 1002 is in a displayable format, the content thereof is displayed. When the obtained data is an HTML document or the like, new resources can be repeatedly obtained and displayed merely by selecting link information embedded as a hypertext in a document displayed on the web browser.

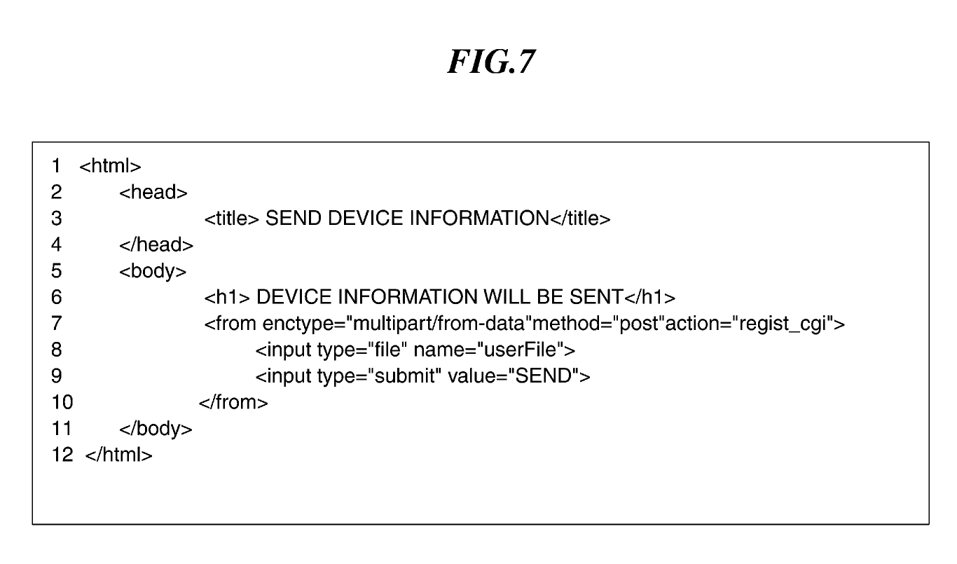

Next, a description will be given of a case where an HTTP request is sent using the POST method. When a form (specific format information) is included in an HTML document, and the POST method is designated as a method of sending the same (see an HTML document in FIG. 7), the following process is carried out. Specifically, information inputted by the user is encoded into a form displayed by the web browser of the client 1001, and the encoded information (the entry in the form) is attached to an HTTP request 1005 and sent to the server 1002. In the server 1002, a designated resource receives the data sent from the client 1001 and carries out a process, and generates and sends an HTTP response 1006 back to the client 1001.

Next, characteristics of how the image processing apparatus 110 (client) having an HTTP client function, and the image processing apparatus 120 (server) having an HTTP server function are controlled in relation to the above described process of request and response using HTTP will be enumerated below.

The image processing apparatus 110 inputs information to the image processing apparatus 120, and sends to the image processing apparatus 120 an HTTP request for requesting screen information including descriptions for setting the information as setting information on the image processing apparatus 120. Then, when an operational screen based on an HTTP response sent from the image processing apparatus 120 in response to the request is to be displayed, an operational screen (web page) for instructing whether to send setting information on the image processing apparatus 110 or select setting information from a box is displayed on the console 112, that is, presented to the user.

It should be noted that at this time, it may be selectively determined whether to display an operational screen according to screen information included in the HTTP response from the image processing apparatus 120 or display an operational screen according to screen information generated by the image processing apparatus 110 instead of screen information included in the HTTP response. In this case, which one of these operational screens is to be displayed is determined based on information in a header field or a body of the HTTP response, or information in the header filed and the body.

The image processing apparatus 120 carries out acceptation process in which the HTTP request from the image processing apparatus 110 is accepted. Further, in response to the HTTP request, the image processing apparatus 120 provides the image processing apparatus 110 with first format information (HTML page data form) for selecting setting information from an HDD of the image processing apparatus 110 and sending the same to the image processing apparatus 120.

FIG. 7 is a view showing an exemplary HTML document that includes a form and for which the POST method is designated as a form transmission method.

Referring to FIG. 7, a tag indicative of the start of an HTML element is written in the first line of the HTML document. A tag indicative of the start of a HEAD element is written in the second line, a tag indicative of a TITLE element included in the HEAD element is written in the third line, and a tag indicative of the end of the HEAD element is written in the fourth line. A tag indicative of the start of a BODY element is written in the fifth line, and an H1 element is written in the sixth line. A tag indicative of the start of a FORM element is written in the seventh line. In this tag, attributes indicate that in this form, input information is encoded in a multipart/form-data format and sent to a regist.cgi resource using the POST method.

The eighth line indicates a first INPUT element. In the first INPUT element, attributes indicate that the name is “userFile” and the type is “file”. The ninth line indicates a second INPUT element. In the second INPUT element, attributes indicate that the type is “submit”, and the value is a character string “send”. A tag indicative of the end of the FORM element is written in the tenth line. A tag indicative of the end of the BODY element is written in the eleventh line. A tag indicative of the end of the HTML element is written in the twelfth line.

FIG. 9 is a view showing an exemplary screen displayed in the content display area 905 of the web browser based on the HTML document shown in FIG. 7. In the client 1001, the operational screen in FIG. 7 is displayed in the content display area 905 in response to the reception of an HTTP response from the image processing apparatus 120. On the illustrated screen, a display corresponding to the H1 element on the sixth line in FIG. 7 is a display 1201. A display corresponding to the file type INPUT element on the eighth line in FIG. 7 is a rectangular display 1202. A display corresponding to the submit type INPUT element on the ninth line in FIG. 7 is a display 1203.

In the area of the display 1202, unique displays 1204 and 1205 characteristic of the web browser of the image processing apparatus 110 are produced. The display 1204 (“Send own apparatus information” button) (second instruction button) indicates a button for starting an act of sending setting information currently set in the image processing apparatus 110. The display 1205 (“Select from box” button) (first instruction button) indicates a button for starting an act of selecting a setting information filed stored in advance in the box in the image processing apparatus 110.

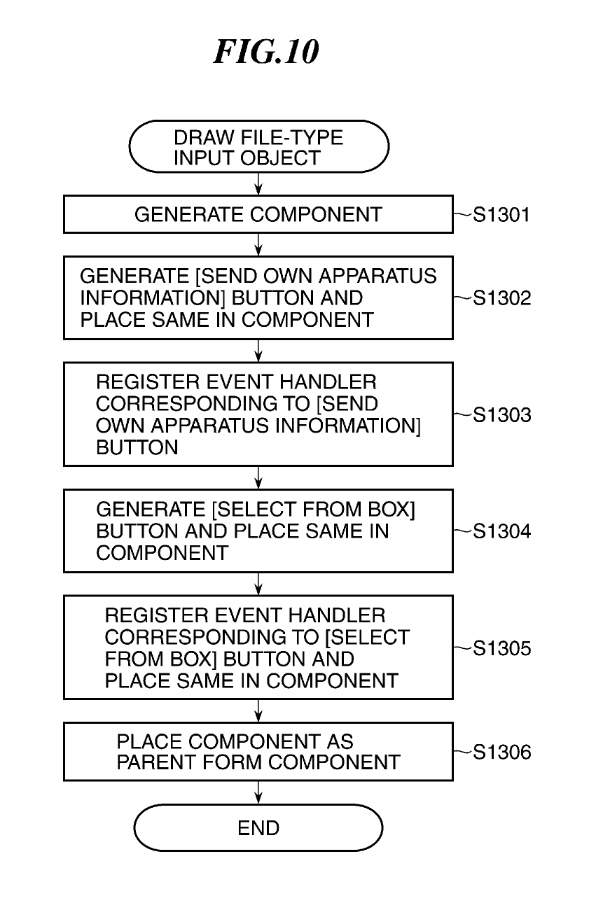

FIG. 10 is a flowchart showing procedures of a layout process on an object corresponding to the file-type INPUT element executed by the web browser of the image processing apparatus 110 (providing unit). Here, the layout process generates a layout corresponding to the display 1202 on the screen shown in FIG. 9.

Referring to FIG. 10, first, the CPU 301 (providing unit) of the image processing apparatus 110 generates a component object as a unit of the layout process (step S1301). Next, the CPU 301 generates a button corresponding to the display 1204 in FIG. 9, that is, the “Send own apparatus information” button and places the same in the component (step S1302). Then, the CPU 301 registers a process for reading setting information currently set in the own apparatus as an event handler that is started when an event depressing the generated “Send own apparatus information” button occurs (step S1303).

Next, the CPU 301 generates a button corresponding to the display 1205 in FIG. 9, that is, the “Select from box” button and places the same in the component (step S1304). Then, the CPU 301 registers a process for selecting setting information from a box as an event handler that is started when an event depressing the generated “Select from box” button occurs (step S1305). After that, the CPU 301 places the components in a component object corresponding to the FORM element in a parent component of the component (step S1306), followed by terminating the process.

In the same manner as the above described manner, a tree structure expressing the inclusive relationship between component objects corresponding to respective elements is generated, and this tree is subjected to a recursive process to lay out a screen display.

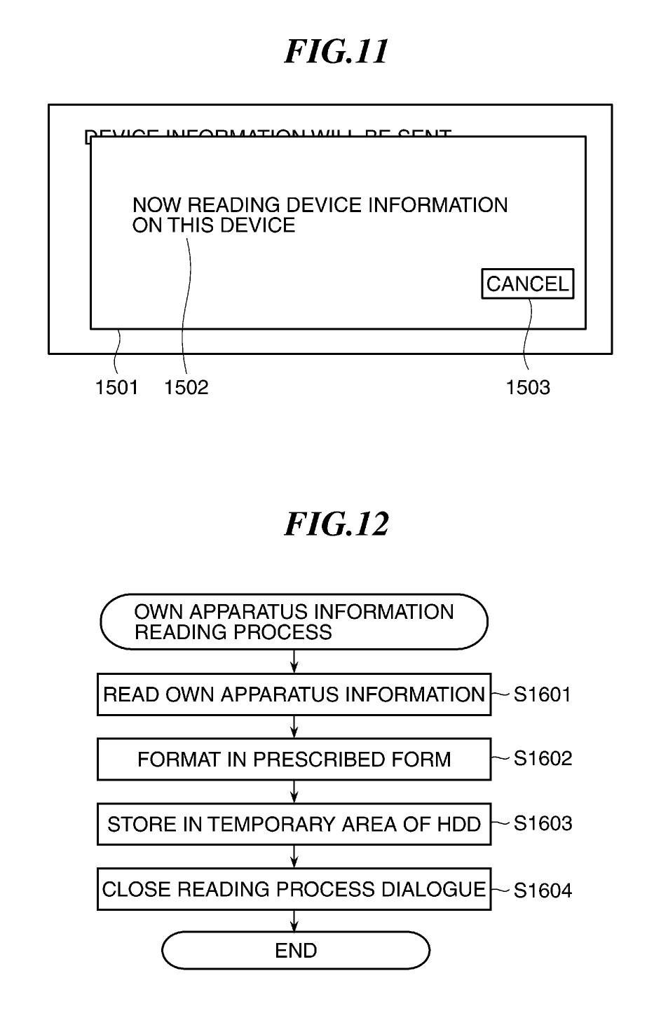

Referring next to FIG. 11, a description will be given of a dialogue window displayed when “Send own apparatus information” is selected on the web browser according to the present embodiment.

FIG. 11 is a view showing an exemplary dialogue window displayed on the web browser of the image processing apparatus so as to read setting information on the own apparatus (apparatus information). Referring to FIG. 11, when the button of the display 1204 in FIG. 9, that is, the “Send own apparatus information” button is depressed by the user, a dialogue window 1501 is displayed in the content display area 905 of the web browser as shown in the figure. In the dialogue window 1501, a message 1502 and a cancel button 1503 are displayed.

The message 1502 tells that the setting information reading process is underway in the image processing apparatus. The cancel button 1503 is depressed to stop the setting information reading process and go back to the screen in FIG. 9. Upon completion of the setting information reading process, the dialogue window in FIG. 11 is deleted, and the screen in FIG. 9 is displayed again.

It should be noted that when the “Send own apparatus information” button is selected on the selection screen in FIG. 9, the process in which setting information on the own apparatus is read from the HDD 304. In this case, operation is carried out such that setting information on the own apparatus is preferentially sent, and hence the selection screen in FIG. 9 is skipped, and the screen in FIG. 11 is displayed.

FIG. 12 is a flowchart showing procedures of the process in which setting information on the own apparatus is read, which is carried out by the image processing apparatus 110.

Referring to FIG. 12, the CPU 301 of the image processing apparatus 110 carries out a process to read setting values such as values currently set in the image processing apparatus 110 and the management information (setting information on the own apparatus) (step S1601). Next, the CPU 301 formats the read setting values in a specified file format (step S1602).

Then, the CPU 301 stores the data formatted in the specified file format in the temporary area of the HDD 304 (step S1603). After that, the CPU 301 closes the reading process dialogue and goes back to the screen in FIG. 9 (step S1604), followed by terminating the process.

It should be noted that when going back to the screen in FIG. 9, the CPU 301 highlights the display 1204 and the display 1203, making it known to the user that a file of setting information on the own apparatus is stored in the HDD 304 and available for transmission.

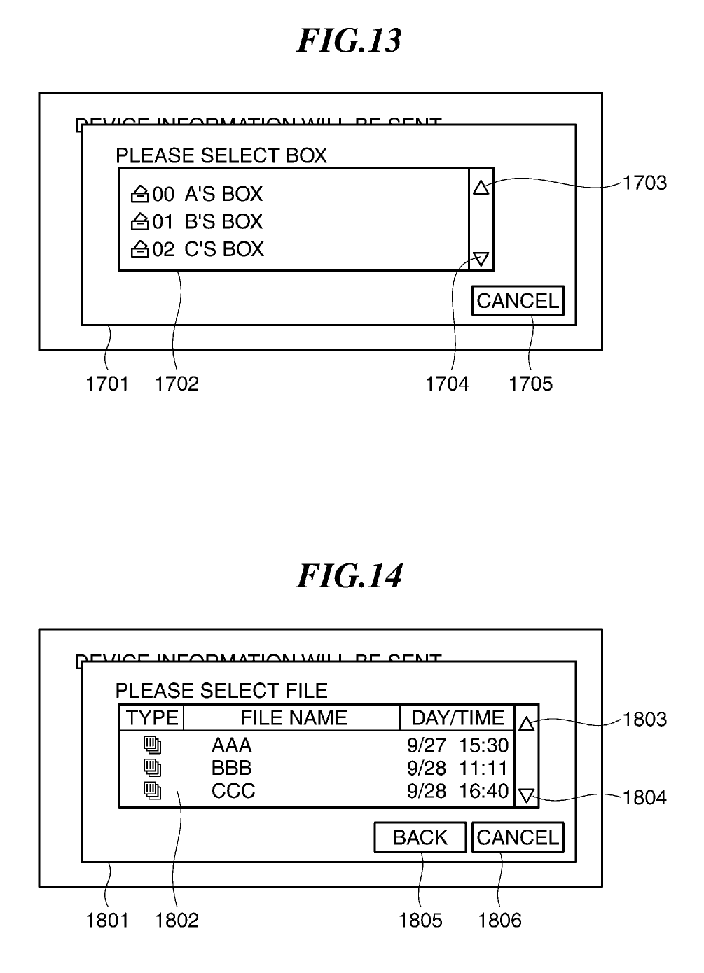

Referring next to FIG. 13, a description will be given of a dialogue window displayed when “Select from box” is selected on the web browser according to the present embodiment.

FIG. 13 is a view showing an exemplary dialogue window displayed so as to select a box in which a setting information file is stored. Referring to FIG. 13, when the button of the display 1205 in FIG. 9, that is, the “Select from box” button is depressed by the user, a dialogue window 1701 is displayed in the content display area 905 of the web browser as shown in the figure. In the dialogue window 1701, a box selection field 1702, a scroll button 1703, a scroll button 1704, and a cancel button 1705 are displayed.

In the box selection field 1702, information about a box (a box number and a box name given to the box) is displayed in each line. When any line is selected, a transition to a screen on which a list of files stored in the selected box in the box area of the HDD 304 is displayed takes place. When the scroll button 1703 or the scroll button 1704 is depressed, the CPU 301 changes the range of boxes to be displayed in the box selection field 1702. The cancel button 1705 is a button for stopping the process and going back to the screen in FIG. 9.

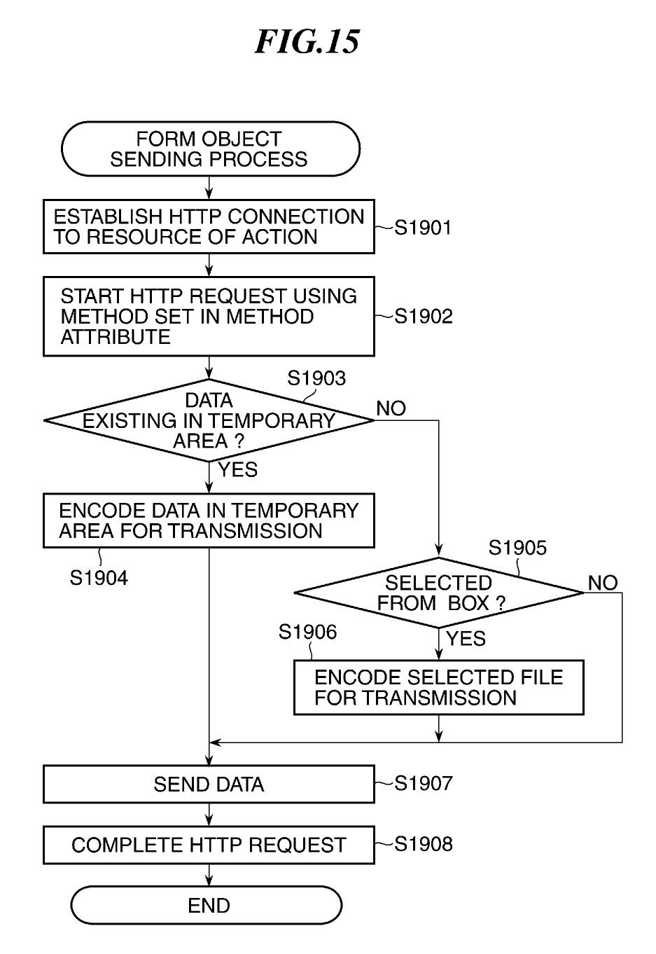

FIG. 14 is a view showing an exemplary dialogue window displayed so as to select a setting information file from a box. Referring to FIG. 14, a dialogue window 1801 is displayed in the content display area 905 of the web browser as shown in the figure. In the dialogue window 1801, a file selection field 1802, a scroll button 1803, a scroll button 1804, a back button 1805, and a cancel button 1806 are displayed.

In the file selection field 1802, information about a file stored in a selected box in the box area of the HDD 304 (a type, a file name, a date and time of update, and so on) is displayed in one line per one file. When any line is selected, the selected file is determined as a file to be sent, and the screen in FIG. 9 is displayed again. In this case, the display 1205 and the display 1203 are highlighted on the screen in FIG. 9, making it known to the user that a device information file has been selected from a box and is available for transmission.

When the scroll button 1803 or the scroll button 1804 is depressed, the CPU 301 changes the range of files to be displayed in a file selection field. The back button 1803 is depressed to go back to the screen in FIG. 13. The cancel button 1806 is depressed to stop the process and go back to the screen in FIG. 9.

It should be noted that when the display 1205 is selected from the box after the setting information file of the own apparatus is stored in the temporary area of the HDD 304, the data stored in the temporary area is deleted, and the highlight of the button 1204 is terminated. Also, when the display 1204 is selected in the state where the display 1205 is highlighted, that is, after a send file is selected from the box, the selection of the selected file is canceled, and the highlight of the button 1205 is terminated. Namely, the new setting takes effect.

FIG. 15 is a flowchart showing the procedure of a form submitting process (form object sending process) carried out by the web browser of the image processing apparatus 110 (setting execution unit). The process is carried out when an event inputting an object corresponding to the submit-type INPUT element occurs. Namely, when an event depressing the “Send” button of the display 1203 in FIG. 9 occurs, the process is carried out in relation to the FORM element including the input element. It should be noted that the implementation of the process is distributed over a plurality of objects, but will be explained as a sequential flow, detailed description of which, therefore, is omitted.

Referring to FIG. 15, first, the CPU 301 of the image processing apparatus 110 (setting execution unit) establishes HTTP connection with a URI resource set in an action attribute of an object corresponding to the FORM element (step S1901). It should be noted that in the case of HTTP 1.1, the step S1901 may be omitted if connection with a sever as a connection target has already been established. Next, the CPU 301 starts an HTTP request using a transmission method set in a method attribute of an object corresponding to the FORM element (step S1902). Here, it is assumed that POST transmission is set as the transmission method.

Next, the CPU 301 checks whether or not a setting information file exists in the temporary area of the HDD 304 (step S1903). When a setting information file exists in the temporary area, the CPU 301 encodes the data in the temporary area according to an encode format (multipart/form-data) set in an enctype attribute of the FORM element (step S1904). On the other hand, when a setting information file does not exist in the temporary area, the CPU 301 determines whether or not a setting information file has been selected from a box (step S1905).

When a setting information file has been selected from a box, the CPU 301 encodes the selected setting information file according to an encode format set in the enctype attribute of the FORM element (step S1906), and proceeds to step S1907. It should be noted that the encode format is multipart/form-data (see FIG. 7). On the other hand, when a setting information file has not been selected from a box, the CPU 301 directly proceeds to the step S1907.

Next, the CPU 301 sends the data encoded in the step S1904 or the step S1906 to the server (step s1907). After that, the CPU 301 completes the HTTP request (step S1908), and terminates the process.

As described above, the CPU 301 has only to request acquisition of setting information using a web page having a form (the same one as the one provided to the host computer 101) that requests file uploading without providing an image processing apparatus, into which the setting information is required to be taken, with special implementations. A user of an image processing apparatus having a web browser incorporated therein can send setting information using a simple operating procedure even when reading and sending setting information currently set in the own apparatus, or when selecting setting information stored in advance in a box.

As described above in detail, according to the present embodiment, in an image processing apparatus having a web browser incorporated therein and an image processing apparatus having a web server incorporated therein, when setting information currently set in the own apparatus is to be taken into the other apparatus, there is no need to take out and prepare the setting information in advance. Thus, it becomes possible to exchange setting information by easy operations in a small number of steps, and this can improve convenience for users.

An image processing apparatus according to a second embodiment of the present invention differs from the image processing apparatus according to the above described first embodiment having the HTTP client function in that the image processing apparatus has an HTTP server function. Component elements of the image processing apparatus according to the present embodiment are the same as the corresponding ones in the above described first embodiment (FIGS. 1 to 4), and therefore, description thereof is omitted.

In the above described first embodiment, the display of an operational screen for instructing to read and send setting information currently set in an image processing apparatus is controlled by a client-side image processing apparatus that sends setting information. On the other hand, in the present embodiment, the above display control is provided by a server-side image processing apparatus that receives setting information. In the present embodiment, the CPU 301 of the image processing apparatus 120 provides control as described below using the web server.

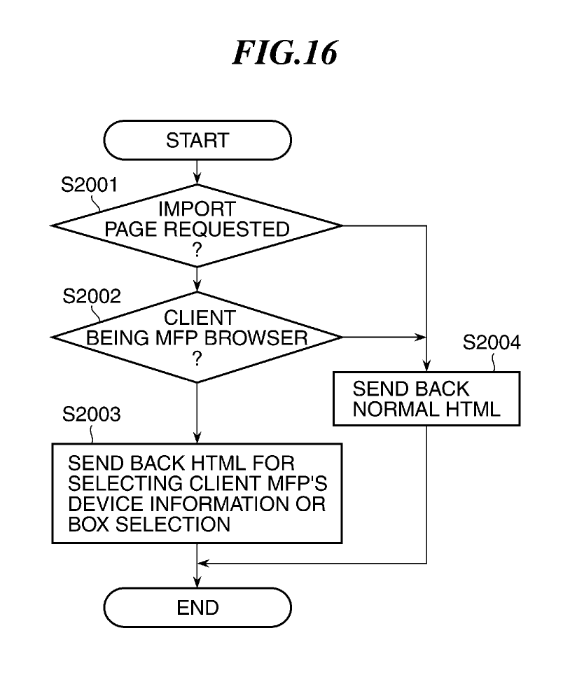

FIG. 16 is a flowchart showing procedures of a process carried out by the web server of the image processing apparatus 120 in a case where a page to which setting information is uploaded is requested according to the present embodiment.

Referring to FIG. 16, the CPU 301 of the image processing apparatus 120 provides control to carry out the following process through the web server. The web server determines whether or not an HTTP request sent from a client is a request for page data for uploading setting information to the image processing apparatus 120 (step S2001). When the HTTP request is a request for page data for uploading setting information, the web server determines whether or not the client is a web client of a specific image processing apparatus (here, the image processing apparatus 110) (step S2002). On the other hand, when the HTTP request is not a request for page data for uploading setting information, the web server proceeds to step S2004.

When the client is a web client of the image processing apparatus 110, the web server carries out a process described hereafter. The web server creates HTML page data for selecting setting information on a web client (client MFP) of the image processing apparatus 110, or selecting a setting information file from another storage device. Then, the web server replies to the web client of the image processing apparatus 110 (step S2003). As a result, a display as shown in FIG. 9 is produced on the web browser of the console 112 of the image processing apparatus 110. On the other hand, when the client is not a web client of a specific image processing apparatus (the image processing apparatus 110), the web server proceeds to step S2004.

Here, by embedding a script (not shown) for causing the image processing apparatus 110 to carry out a setting information sending-out process in response data for the image processing apparatus 110, it is possible to inhibit a user of the image processing apparatus 110 from carrying out the selecting operations as shown in FIG. 9. It can be said that this is more convenient considering backup of setting information.

On the other hand, when in the step S2001, the HTTP request is not a request for page data for uploading setting information, or when in the step S2002, the client is not a web client of a specific image processing apparatus (the image processing apparatus 110), the web server carries out a process described hereafter.

Specifically, when the HTTP request is page data unrelated to uploading of setting information, or when the client is not a web client of a specific image processing apparatus (an ordinary PC), the web server makes a reply described hereinafter. The web server sends normal HTML data (see FIG. 7) to the web client of the image processing apparatus 110 (step S2004).

After that, the CPU 301 of the image processing apparatus 120 receives information sent in response to the user's instruction given via the operational screen shown in FIG. 9 (setting information currently set in the image processing apparatus 110 or information selected from the storage device of the image processing apparatus 110). Then, the CPU 301 carries out a process to set the received information as setting information on the image processing apparatus 120.

As described above in detail, according to the present embodiment, similarly to the above described first embodiment, it becomes possible to exchange setting information by easy operations in a small number of steps, and this can improve convenience for users.

Although in the first embodiment, it is configured such that for the convenience of explanation, two alternatives, i.e. “Send own apparatus information” and “Select from box” are taken as examples of alternatives in sending setting information from an image processing apparatus to another image processing apparatus, the present invention is not limited to this. It goes without saying that the present invention encompasses possible expansions, for example, a case where a portable medium such as a USB memory is connected to an image processing apparatus, and a case where setting information is selected from a file server on a network.

Although in the first and second embodiments, a storage area for setting information is provided in an HDD of an image processing apparatus, the present invention is not limited to this. It may be configured such that a storage area for setting information may be provided in an external device such as a computer.

Although in the first second embodiments, a destination to which a fax is sent, and an address book are taken as examples of setting information on an image processing apparatus, the present invention is not limited to this. Setting information on an image processing apparatus may be arbitrary information determined according to a usage pattern of the image processing apparatus.

Although in the first and second embodiments, the system shown in FIG. 1 is taken as an example, the present invention is not limited to this. For example, the numbers of image processing apparatuses and computers to be installed may be arbitrarily determined without departing from the scope of the invention.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-035399 filed Feb. 18, 2009, which is hereby incorporated by reference herein in its entirety.

What is claimed is:

1. An image processing apparatus connected to an external device via a network, comprising:
a requesting unit adapted to request, from the external device, screen information including a first instruction button for inputting information to the external device and instructing to set the inputted information as setting information on the external device;
a display unit adapted to display an operational screen based on a response from the external device in response to the request by said requesting unit;
a providing unit adapted to provide a user with a second instruction button for instructing to set setting information currently set in the image processing apparatus as setting information on the external device when said display unit displays the operational screen.

2. An image processing apparatus as claimed in claim 1, wherein said providing unit causes said display unit to display the operational screen including both the first instruction button and the second instruction button.

3. An image processing apparatus as claimed in claim 1, further comprising a generation unit adapted to generate screen information to be displayed on the operational screen,
wherein said display unit displays the operational screen based on the screen information generated by said generation unit, not screen information included in the response from the external device.

4. An image processing apparatus as claimed in claim 1, further comprising a setting execution unit adapted to, when an instruction is given by the user using the second instruction button, read the setting information currently set in the image processing apparatus and send the same to the external device, whereby the read setting information is set as setting information on the external device.

5. An image processing apparatus as claimed in claim 4, further comprising a storage unit adapted to store a plurality of pieces of information,
wherein when an instruction is given by the user using the first instruction button, said setting execution unit sends a piece of information selected by the user from among the plurality of pieces of information stored in said storage unit, whereby the selected information is set as setting information on the external device.

6. An image processing apparatus as claimed in claim 1, wherein
the external device has a web server function, and
said display unit has a web browser function of analyzing an HTML file sent from the external device, and displaying an operational screen according to the HTML file.

7. A server apparatus connected to an image processing apparatus via a network, comprising:
a receiving unit adapted to receive from the image processing apparatus a request for screen information including a first instruction button for inputting information to the server apparatus and instructing to set the inputted information as setting information on the server apparatus;
a determination unit adapted to determine whether the image processing apparatus that has made the request is a specific image processing apparatus when said receiving unit receives the request; and
a transmission unit adapted to, when as a result of the determination by said determination unit, the image processing apparatus that has made the request is a specific image processing apparatus, send screen information for displaying an operational screen including the first instruction button for instructing to input information selected by a user from information stored in a storage unit of the image processing apparatus to the server apparatus so as to set the selected information as setting information on the server apparatus, and a second instruction button for instructing to read setting information currently set in the image processing apparatus and inputting the read setting information to the server apparatus so as to set the read setting information as setting information on the server apparatus to the image processing apparatus that has made the request.

8. A server apparatus as claimed in claim 7, further comprising a setting unit adapted to receive information sent from the image processing apparatus in accordance with an instruction form the user using the first instruction button or the second instruction button, and set as setting information on the server apparatus.

9. A server apparatus as claimed in claim 7, wherein
the image processing apparatus has a web browser function, and
the server apparatus has a web server function of sending an HTML file as the screen information for displaying the operational screen to the image processing apparatus.

10. A control method for an image processing apparatus connected to an external device via a network, comprising:
a requesting step of requesting, from the external device, screen information including a first instruction button for inputting information to the external device and instructing to set the inputted information as setting information on the external device;
a display step of displaying an operational screen on a display unit based on a response from the external device in response to the request in said requesting step;
a providing step of providing a user with a second instruction button for instructing to set setting information currently set in the image processing apparatus as setting information on the external device when the operational screen is displayed in said display step.

11. A control method for a server apparatus connected to an image processing apparatus via a network, comprising:
a receiving step of receiving from the image processing apparatus a request for screen information including a first instruction button for inputting information to the server apparatus and instructing to set the inputted information as setting information on the server apparatus;
a determination step of determining whether the image processing apparatus that has made the request is a specific image processing apparatus when the request is received in said receiving step; and
a transmission step of, when as a result of the determination in said determination step, the image processing apparatus that has made the request is a specific image processing apparatus, sending screen information for displaying an operational screen including the first instruction button for instructing to input information selected by a user from information stored in a storage unit of the image processing apparatus to the server apparatus so as to set the selected information as setting information on the server apparatus, and a second instruction button for instructing to read setting information currently set in the image processing apparatus and inputting the read setting information to the server apparatus so as to set the read setting information as setting information on the server apparatus to the image processing apparatus that has made the request.

12. A computer-readable storage medium storing a program for causing a computer to execute a control method for an image processing apparatus as claimed in claim 10.

13. A computer-readable storage medium storing a program for causing a computer to execute a control method for a server apparatus as claimed in claim 11.
